(19) United States
(12) Patent Application Publication
(10) Pub. No.: US 2011/0254687 A1
(43) Pub. Date: Oct. 20, 2011

(54) METHOD AND APPARATUS FOR ACTIVATING A DEVICE

(75) Inventors: Jarmo Tapani Arponen, Espoo (FI); Jari-Jukka Harald Kaaja, Jarvenpaa (FI); Markku Anttoni Oksanen, Helsinki (FI); Jouni Olavi Kossi, Espoo (FI); Sergey Boldyrev, Soderkulla (FI); Joni Jorma Marius Jantunen, Helsinki (FI); Antti Tuomas Lappetelainen, Espoo (FI); Ian Justin Oliver, Soderkulla (FI)

(73) Assignee: Nokia Corporation, Espoo (FI)

(21) Appl. No.: 13/086,087

(22) Filed: Apr. 13, 2011

Related U.S. Application Data
(60) Provisional application No. 61/324,588, filed on Apr. 15, 2010.

(51) Int. Cl. G05B 19/00; G06F 11/00; G08B 21/00

(52) U.S. Cl. 340/540; 340/5.8; 726/34

(57) ABSTRACT

An approach is presented for activating a device. The activation platform receives a request to make a device operable, wherein the device is in an inoperable state because one or more components for operating the device are absent from the device. Further, the activation platform, in response to the request, validates an authenticity of the device based, at least in part, on one or more identifiers associated with the device. Then, the activation platform retrieves the components. Then, the activation platform causes, at least in part, transfer of the components to the device to make the device operable.

### RELATED APPLICATIONS

This application claims the benefit of the earlier filing date under 35 U.S.C. §119(e) of U.S. Provisional Application Ser. No. 61/324,588 filed Apr. 15, 2010, entitled “Method and Apparatus for Activating a Device,” the entirety of which is incorporated herein by reference.

### BACKGROUND

Device manufacturers (e.g., wireless, cellular, etc.) are continually challenged to deliver value and convenience by, for example, providing innovative and efficient features. One area of interest is the development of mechanisms for preventing theft of devices especially during retail operations, between the time of the delivery of the devices from the manufacturer to the retailer's storage space and the time the device is purchased. In particular, the device manufacturers as well as the retailers desire a secure way to deliver a device from the manufacturer to the hands of a customer. It is noted that mobile devices are considered easy and potentially lucrative targets for theft because they are small and often have considerable value. Because of the possible thefts, the manufacturers and the retailers of the mobile devices often incur additional costs to mitigate or prevent losses from the theft. Accordingly, the device manufacturers face significant challenges to enable effective ways to make the devices and related peripherals (e.g., memory units or cards, with or without additional content, media trailers, etc.) available for sale while minimizing or preventing theft of such devices.

### SOME EXAMPLE EMBODIMENTS

Therefore, there is a need for an approach for effectively and efficiently preventing or otherwise discouraging theft of devices by rendering the device intentionally inoperable and then triggering activation of the inoperable device on request (e.g., as part of a valid transaction or sale of the device). The components for operating the device in this invention may be physical components and/or software components.

According to one embodiment, a method comprises receiving a request to make a device operable, wherein the device is in an inoperable state because one or more components for operating the device are absent from the device. The method also comprises, in response to the request, validating an authenticity of the device based, at least in part, on one or more identifiers associated with the device. The method further comprises retrieving the components. The method further comprises causing, at least in part, transfer of the components to the device to make the device operable.

According to another embodiment, an apparatus comprising at least one processor, and at least one memory including computer program code, the at least one memory and the computer program code configured to, with the at least one processor, cause, at least in part, the apparatus to receive a request to make a device operable, wherein the device is in an inoperable state because one or more components for operating the device are absent from the device. The apparatus is also caused to validate, in response to the request, an authenticity of the device based, at least in part, on one or more identifiers associated with the device. The apparatus is further caused to retrieve the components. The apparatus is further caused to cause, at least in part, transfer of the components to the device to make the device operable.

According to another embodiment, a computer-readable storage medium carrying one or more sequences of one or more instructions which, when executed by one or more processors, cause, at least in part, an apparatus to receive a request to make a device operable, wherein the device is in an inoperable state because one or more components for operating the device are absent from the device. The apparatus is also caused to validate, in response to the request, an authenticity of the device based, at least in part, on one or more identifiers associated with the device. The apparatus is further caused to retrieve the components. The apparatus is further caused to cause, at least in part, transfer of the components to the device to make the device operable.

According to another embodiment, an apparatus comprises means for receiving a request to make a device operable, wherein the device is in an inoperable state because one or more components for operating the device are absent from the device. The apparatus also comprises means for, in response to the request, validating an authenticity of the device based, at least in part, on one or more identifiers associated with the device. The apparatus further comprises means for retrieving the components. The apparatus further comprises means for causing, at least in part, transfer of the components to the device to make the device operable.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of activating a device, according to one embodiment;

FIG. 2 is a diagram of the components of the activation platform, according to one embodiment;

FIG. 3 is a diagram of the components of the user equipment, according to one embodiment;

FIGS. 4A and 4B are flowcharts of a process for activating a device, according to various embodiments;

FIG. 5 is a flowchart of a process for providing the most current software components to the user equipment, according to one embodiment;

FIGS. 6A and 6B are diagrams of the processes for activating a device and user interfaces utilized at the retailer device during the processes of FIGS. 4A and 4B, according to various embodiments;

FIG. 7 is a diagram of selectively receiving a data image source by waving and sweeping the user equipment near the data image source, according to one embodiment;

FIGS. 8A-8E are example diagrams of a memory tag with a tag hardware for short range wireless communication;

FIG. 9 shows an example of a volatile memory that may be used for an eTag, according to one embodiment;

FIG. 10 is a diagram of hardware that can be used to implement an embodiment of the invention;

FIG. 11 is a diagram of a chip set that can be used to implement an embodiment of the invention; and

FIG. 12 is a diagram of a mobile terminal (e.g., handset) that can be used to implement an embodiment of the invention.

### DESCRIPTION OF SOME EMBODIMENTS

Examples of a method, apparatus, and computer program for activating a device are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term information space or smart space can be considered as an information set aggregated from a variety of different and distributed sources. The multi-sourcing of information gives an information space great flexibility and accounts for the fact that the same piece of information can come from different sources and different owners. Although various embodiments are described with respect to information spaces, it is contemplated that the approach described herein may be used with other distributed information sets.

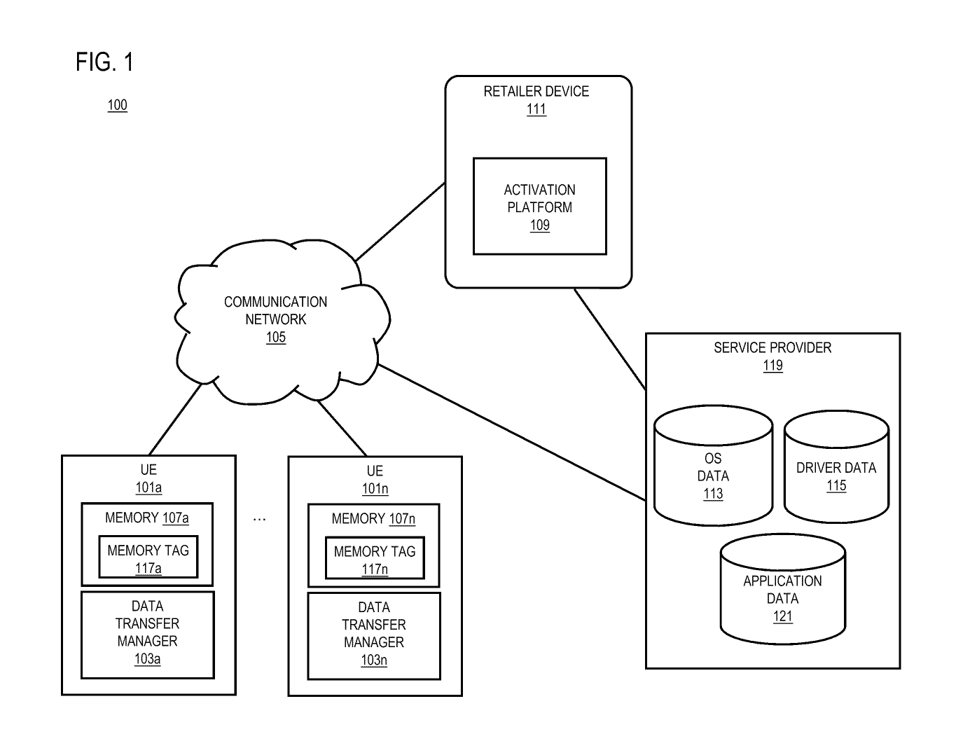

FIG. 1 is a diagram of a system capable of activating a device, according to one embodiment. As discussed previously, mobile devices historically have been common targets of theft because of their size and potential value. Conventional anti-theft mechanisms such as locks, alarms, etc., may make it more difficult for a theft to steal devices protected by such mechanisms, but have limited if any further effectiveness once the mechanism is circumvented. In other words, once a conventional anti-theft mechanism is circumvented the devices remain attractive target for thieves.

To address this problem, a system 100 of FIG. 1 introduces a retail model for devices in which devices move from the manufacturing to retail in an inoperable condition and then made operable (e.g., via an activation process) when, for instance, a end user purchases the device at retail. In one embodiment, the device is made inoperable during manufacturing by shipping the device from the factory to retail with all or a portion of its components (e.g., firmware components, operating system components, key software components, and other application (binary or script) software components, etc) missing so that the device cannot function. The device is then made operable (e.g., by providing or restoring the missing components to the device) when a transfer of ownership, sale, lease, etc. of the device is made. This transfer of ownership, sale, lease, etc. of the device may be made with or without any additional user-selected content, local variants, credentials, configurations, etc. valid for the device chosen to be made operable. In this way, the device would have little to no value to the device because it will be inoperable unless otherwise made operable. In one embodiment, the process for rendering an inoperable device can only be performed via a properly authenticated terminal (e.g., a retail point-of-sale terminal or the like), wherein the authenticated terminal may include an authorized retailer writer for wireless flashing to the device to make the device operable. In this way, the incentive to steal the device is reduced because the device would be inoperable and have little if any value without proper activation.

More specifically, system 100 enables receiving a request at a component source to retrieve components for operating the UE 101, and the component source provides the UE 101 with the corresponding component according to the request information from the UE 101 including authentication information and parameters of the UE 101. The component necessary to make the UE 101 operable may be a software component, which may be provided by a data source such as a Nokia server or any other third party data provider. A user of a communication system generally has access to various storage means such as a server storage, local mass-storage, external storage devices (e.g., portable memory sticks), or a combination thereof, where content is gradually transferred (e.g., backed up, synchronized, copied, replicated, etc.). In one embodiment, a distributed information gathering technology (e.g., an information space) can operate over these various storage locations and devices to determine software component to be exchanged and then exchange this software component with the UE 101 in a form that is compatible with the UE 101 in order to activate (or deactivate) the UE 101.

The UE 101 has a memory to store data including an operating system, software applications, digital media and etc. The memory may include a non-volatile memory (NVM) such as a flash memory, universal file storage/Execute in Place (UFS/XIP) type PCM memory, etc. In one embodiment, the software component to be transferred to the UE 101 from the data source may also be determined based on memory tags associated with the UE 101, such as an RF memory tag. The mobile device can then read the data from the memory and activate (or deactivate) the mobile device according to the data. As an example of the UE including the RF memory tag (e.g. NVM PCM memory and a RF part), the UE 101 may act as a passive end point that is turned off without power or an active end point with power on. For the passive end point, the writer at the retailer device 111 may provide power and data to the passive end point UE, whereas the writer at the retailer device 111 may provide only data to the active end point UE. Examples of the active end point UE may include a new device out from a sales box with a battery power on, or an old device that has become dead or non-working and needs to be repaired or activated. In one embodiment, the RF memory tag uses short range connectivity such as Ultra High Frequency/Near Field Communication (UHF/NFC) and/or Impulse based Ultra Wideband (I-UWB). UHF/NFC may be produced by an end unit such as a reader or a writer at the retailer device 111 and may be used to provide a power field (thus controlling the UE with this power field), whereas I-UWB may be used for data transfer between the memory tags of the either the writer device or the reader device, wherein the short range connectivity may be provided as a structure embedded with the RF memory tag or as a peripheral device connected to the RF memory tag. The RF memory tag may also be present as a part of the data source using a retailer writer device, such that data can be transferred from the data source to the UE 101 using a short range connectivity, wherein the data can be transferred to a RF memory tag embedded in the UE 101 or another storage medium supporting a UFS/XIP memory architecture in the UE 101, for example. The embedded RF memory tag in the UE 101 may also support the UFS/XIP. Thus, the writer at the retailer device 111 may perform a wireless flashing to the RF memory tag (e.g. eTag) embedded in the UE 101 or to a main storage medium of the UE 101 for execution of software components. Further, this approach may provide a high capacity NVM memory with a RF part providing a high data rate of transfer.

According to one embodiment, software data such as OS data, application data, and driver data are available in the service provider 119. Metadata may also be added to the software data to include information about the software data including data type, data format, data volume, data location, etc. to describe how the information is used and stored in the devices such as the UE 101. The combination of the software data and the metadata may be transferred to, for instance, a passive embedded RF memory tag in the target device. If the information is transferred to a target device, the information is unpacked from its stored form (e.g., the binary block) to be available in the knowledge processors available in the target device.

Also, in one embodiment, a pre-install data image is transferred from the retail device 111 to the UE 101 at retail. The pre-install data image is not yet activated at this stage, but is still a valid software component for the UE 101. The pre-install data image may be later activated by verifying the pre-install data image with an activation code. Thus, without a valid activation code, the pre-install data image is not valid or functional. The pre-install data image may be activated with the activation code at various locations. The activation code is obtained from a source of the activation code such as the service provider 119 or the retail device 111 or another user device. In this embodiment, the pre-install data image may be data that can be streamed, such as an audio or a video file. Then, the pre-install data image may be streamed when the pre-install data image is activated with the activation code. Further, multiple pre-install data images may be provided to the UE 101 during a pre-install process. Then, a user can selected a pre-install data image from the multiple images, and provide an activation code corresponding to the desired image to activate the desired pre-install image. For example, this embodiment may be used for geographical customization, depending on a location that the UE 101 is to be used (e.g. different countries).

As shown in FIG. 1, the system 100 comprises a user equipment (UEs) 101a-101n having connectivity to a data transfer manager 103 via a communication network 105. The data transfer manager 103 may act as an interface between one or more UEs 101 and one or more information spaces 111. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like. The communication network may also involve a connection between a device of an active end point and a device of a passive end point, wherein the active end point provides a power field to the passive end point via a short range radio or wireless connection (e.g. UHF/NFC) and provides a data connection (e.g. I-UWB) between the device of the active end point and the device of the passive end point. In one example, the device of the active end point may be the writer device at the retailer device 111 and the device of the passive end point may be the RF memory tag with short range wireless connectivity at the UE 101. However, any device may be the active end point or the passive end point.

The UEs 101a-101n is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), or any combination thereof. It is also contemplated that the UEs 101a-101n can support any type of interface to the user (such as “wearable” circuitry, etc.). In one embodiment, each of the UEs 101a-101n may include a respective memory 117 to store data. The memory 107 may include a memory tag 117. In addition or alternatively, the memory tag 117117 may be external to the UE 101 (e.g., connected via an external dongle device). By way of example, the memory tag 117 is a near field communication (NFC) tag, radio frequency identification (RFID) tag, contactless card, a wirelessly powered memory tag, or the like that includes sufficient memory to store information related to the respective UE 101. The memory tag 117, for instance, is associated (e.g. embedded in or attached to) one or more of the UEs 101 capable of supporting the information management processes of the approach described herein. In one embodiment, the memory tag 117 (e.g. the RF memory tag or embedded RF memory tag) is a high memory capacity NFC tag that contains several gigabits of memory with fast access and download times. It is contemplated that the memory tag 117 may also be any similar wirelessly powered memory tag. In one example, UHF/NFC or any radio that provides a power field may power the memory tag 117. Further, the memory 107 may also include a one time programming (OTP). The OTP memory may be flashed to add data to the OTP memory.

By way of example, NFC, RFID, contactless card, and similar technologies are short-range wireless communication technologies (e.g., Ultra High Frequency/Near Field Communication (UHF/NFC) and/or Impulse based Ultra Wideband (I-UWB)) that enable the exchange (e.g., both reading and writing) of data between devices and tags over short distances (e.g., the range for NFC is approximately 4 inches). In general, these technologies comprise two main components, a tag (e.g., attached to a UE 101, as an embedded structure such as a RF memory tag card or as an accessory such as a separate entity that the UE 101 and/or the retailer device 111 accesses wirelessly) and a reader/writer (which can be implemented within the UE 101). Communication between the reader/writer and the tags occur wirelessly and may not require a line of sight between the devices. The tag (e.g., an RFID transponder) is, for instance, a small microchip that is attached to an antenna. The tags can vary in sizes, shapes, and forms and can be read through many types of materials. Moreover, the tags may be passive tags or active tags. Passive tags are generally smaller, lighter, and less expensive than active tags. Passive tags are only activated when with the response range of a reader/writer. In other words, passive tags are typically memory tags that are wirelessly powered by the reader/writer. The reader/writer emits a low-power radio wave field that is used to power the tag so as to pass on any information that is contained on the chip. Active tags differ in that they incorporate their own power source to transmit rather than reflect radio frequency signals. Accordingly, active tags enable a broader range of functionality like programmable and read/write capabilities. The read/write capabilities of the memory tag 117 can, for instance, enable the system 100 to write comments for storage in the memory tag 117 for retrieval by other users or update the content of the memory tag 117 to include the latest content. For example, a memory tag 117 associated with an advertisement can be updated to contain the latest pricing and availability information. As another example, a memory tag associated with media such as media content, media trailer, or applications, the latest data image, trial versions, configurations, etc. may be updated to contain the up-to-date information or content. In this example, if an external RF memory tag is used and can be plugged to various devices, then local variants as well as device variants may be flashed, at the time of purchase, for example.

A reader/writer device typically contains a transmitter, receiver, control unit, and an antenna, as well as a memory, which may be a high capacity memory storage. The memory may include an embedded tag. The reader/writer performs several primary functions: energizing/powering the tag, demodulating and decoding the returned radio signal, transferring data, and providing clock information. In certain embodiments, a reader/writer includes an additional interface to convert the returned radio signal to a form that can be passed to another system such as a computer or programmable logic controller.

In one embodiment the UEs 101a-101n communicate with one or more information spaces 111, where the communication of data between the UEs 101a-101n and the service provider 119 is managed by the activation platform 109. The activation platform 109 performs exchange of information between the UEs 101a-101n and the service provider 119 according to the authenticity of the UE 101 as well as the authentication of the transmission. For example, the activation platform 109 may perform verification and validation check, such that the UE 101 may be provided with a proper software components as well as other user selected variants and that the information from the service provider 119 is a proper format for the UE 101.

In yet another embodiment, the UEs 101a-101n may be equipped with a data transfer manager 103 that has the capability of direct communication with the service provider 119. The data transfer manager 103 may include one or more components for receiving the OS data, the driver data and/or the application data as well as other types of data from the service provider 119. The data transfer manager 103 may also authenticate the data source (e.g. the retailer device 111) by validating that the data source is a proper data source to transfer the components. If the authentication of the data source is validated, the data transfer manager 103 allows transfer of the components from the data source to the UE 101.

Therefore, the advantage of this approach is that the mobile device is not activated until the components necessary to activate the mobile device is transferred to the mobile device. The components may be software components that are absent from the device and are necessary to make the mobile device operable. These software components may be provided to the mobile device upon an indication of purchase of the mobile device. Because the mobile device is not operable without these software components, and the purchase is necessary to activate the mobile device, theft of the mobile device is deterred. Thus, this approach reduces the cost incurred by a manufacturer or a retailer in monitoring the mobile devices against theft, as well as any theft insurance cost. Therefore, means for activating a device is anticipated.

An service provider 119 includes various data types for activating various software or firmware. These data may include the OS data 113, which may be used to provide the UE 101 with operating system software or firmware component to boot up the UE 101. The driver data 115 contains drivers for various software or firmware such that the software or the firmware may be available to the user upon retrieval of the drivers at the UE 101. The application data 121 contains software or firmware updates or additional data to be provided for an existing application at the UE 101. The application data may include application data for at least three different classes including purely binary (non-interpreting) class, purely scripting class (e.g. Javascript, Python, PHP, HTML and etc) and Interpreting Framework (e.g. Java code JVM→ByteCode).

It is also noted that due to the distributed nature of information spaces, the service provider 119 can be distributed over several devices in various locations. This means that each of the OS data 113, the driver data 115 and the application data 121 as well as other types of data related to the user of the UE 101 (not shown) may also be of a distributed nature. For example, a user information related to the UE 101 may be stored on one device such as a service provider server storage while on another device in another location which is still within the information space environment.

By way of example, the UE 101, the data transfer manager 103, the activation platform 109 and the service provider 119 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

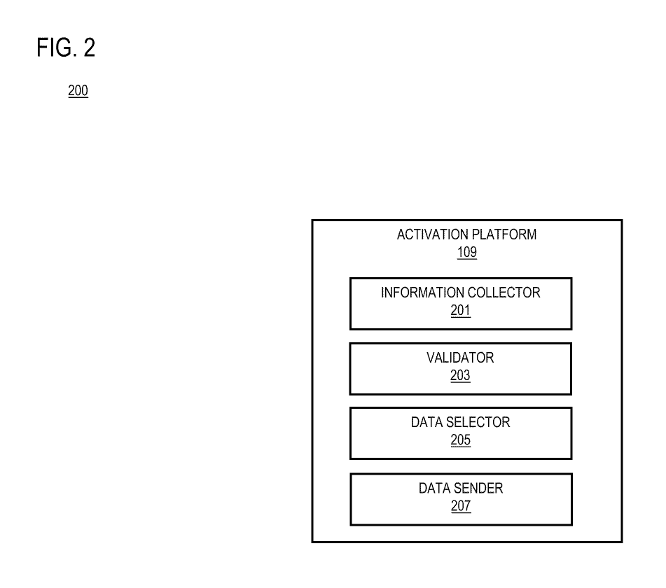

FIG. 2 is a diagram of the components of activation platform 109, according to one embodiment. By way of example, the activation platform 109 includes one or more components for activating a device. It is contemplated that the functions of these components may be combined in one or more components or performed by other components of equivalent functionality. In this embodiment, the activation platform 109 includes an information collector 201, validator 203, data selector 205 and a data sender 207.

In one embodiment, the activation platform 109 receives a request to activate the UE 101. In one example, the retailer may request to activate the UE 101 upon a receipt of payment for the UE 101. The activation of the UE 101 may be a permanent activation, or may be a temporary activation with a time limit, where the UE 101 is rented for a limited time period or the UE 101 is a mobile phone with prepaid minutes, for example. The information collector 201 collects this request and gathers information such as identifiers associated with the UE 101 (e.g., hardware identifiers or software identifiers embedded or otherwise associated with the UE 101 at the time of manufacture). The information collector 201 may also detect a memory tag associated with the UE 101 and extract information about the UE 101 and the user of the UE 101 from the memory tag. In another example, the activation platform 109 may be linked with a memory tag such as a RF memory tag at the retail device 111, and the memory tag at the retail device 111 may be matched with the identifiers associated with the UE 100. The validator 203 validates the authenticity of the UE 101 based on the identifiers associated with the UE 101, such that devices without proper authenticity (e.g. counterfeit devices) will be screened out by the validator 203, by blocking any data transfer from the retail device 111 or even deactivating the counterfeit device, for example. Then, the data selector 205 retrieves the software components that are necessary to activate the UE 101. The data selector 205 may further rely on the information extracted from the memory tag of the UE 101 to determine which software components to retrieve. Then, the data sender 207 transfers the software components to the UE 101 such that the UE 101 can be activated. In one embodiment, the data sender 207 transfers the software components to a one time programming (OTP) memory portion of the UE 101, by flashing to the OTP memory, for example. The software components flashed to the OTP memory may be the components that may not be changed later. In one embodiment, some software components are flashed to the OTP memory and other software components may be stored in a NVM memory such as the UFS/XIP memory. In one example, factory software components may be flashed to the OTP memory portion of the UE 101 at a factory when the UE 101 is manufactured, and then other user selected variants such as language, credentials and contents may be flashed to the OTP memory portion or to other memory portion at retail. In this example, the writer device at the retail device 111 may check the bootloader to determine that the selected content at the retail device 111 will match to the factory software components residing in the OTP memory portion. If there is a match, then the writer device transfers the selected content to the UE 101, such that the factory software components in the OTP memory portion may work with the selected content to activate the UE 101.

The data sender 207 may also authenticate the transmission of the software components, and prevent transmission of the software components if the transmission of the software components is not authenticated. For example, the user of the UE 101 may need to send a payment to the activation platform 109 or send in an authentication code (which may represent a payment) to authenticate the transmission. Thus, the software components may include unique identifiers relevant for verifications and validations, and may also contain a test software portion or a particular functionality data image. The software components may include at least operating system software components, driver software components and update software components. The operating system software components may be transferred to the UE 101 in order to enable the UE 101 to boot up. The driver software components enable a corresponding software application in the UE 101 to function. The update software components provide updates to various aspects of the UE 101.

In one embodiment, the data sender 207 may send the software components without storing or flashing the software components at the memory 107 of the UE 101 at first. Instead, the software components may be fetched to the UE 101 while the UE 101 is connected to the retailer device 111, and may be utilized via this data connection. This data connection may be a short range wireless connection provided by a tag hardware connected to a memory tag 117 in the UE 101 or a memory tag in the retailer device 111. In one example, the UE 101 may not have a firmware, but the software component with the firmware image may activate the UE 101 via the data connection with the retailer device 111.

In another embodiment, the information collector 201 may collect a local copy of the software components and determine whether the local copy is current. If the local copy is not current, then the information collector 201 may request a current copy of the software components.

Further, in another embodiment, the information collector 201 may also receive a request to preview the software components. Then, the data selector 205 will select the corresponding software components for preview (e.g. a demo software with limited features or with time limits such as 24 hour trial period) or the software components for demo phones available only at the stores, and have the data sender 207 transmit the software components to the UE 101.

Also, in another embodiment, the pre-install data image may be transferred from the retailer device 111 to the UE 101, so that the pre-install data image may be activated later via an activation code. The data selector 205 may select the pre-install data image to transfer to the UE 101, based on the information gathered from the information collector 201. The data sender 207 may send the pre-install data image from the retailer device 111 to the UE 101. When the pre-install data image is transmitted to the UE 101, the pre-install data image may be transmitted as a binary image, and may be transmitted to the memory 107 of the UE 101, such as the memory tag 117.

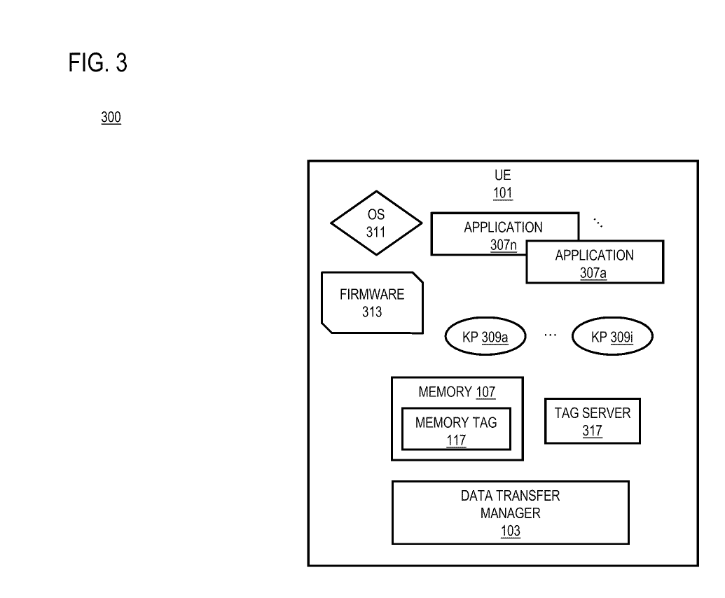

FIG. 3 is a diagram of the components of the UE 101, according to one embodiment. The UE 101 contains an operating system 311 as well as applications 307a-307n that are software services provided by the UE 101 to the user such as contact list manager, tools (e.g., calculator, alarm clock, etc.), music organizer/player, photo albums, email reader, text messenger, etc. The firmware 313 may not be activated to make the UE 101 operable until necessary software components are received and added to the firmware 313. Also, the operating system 311 may not be operable until the software components are received from the service provider 119, and the software services may not be available (i.e. not activated) until the software components are received from the service provider 119. The applications may be applied on the data stored locally in the OTP memory (not shown) of the UE 101, in a memory tag 117 or in an external location as part of an information space 109 accessible by the UE 101 through the communication network 105. The UE 101 may also include the data transfer manager to manage the reception of the software components from the service provider 119, and also to monitor transmission of information about the UE 101, such as the identifiers and/or information from the memory tag 117 associated with the UE 101.

The knowledge processors KP 309a-309i are components that process the user data with regards to an information space 109 that the UE 101 has connectivity to. A knowledge processor 309 may be located in various locations throughout the information space 109 environment, including the UE 101.

In one embodiment, the memory tag 117 can be an internal component of the UE 101 (e.g., an embedded tag) or an external storage device and/or knowledge processor 309 connected to the UE 101. The tag server 317 manages the access to memory tag 117 and operations such as reading, writing and organizing of information on the memory tag 117.

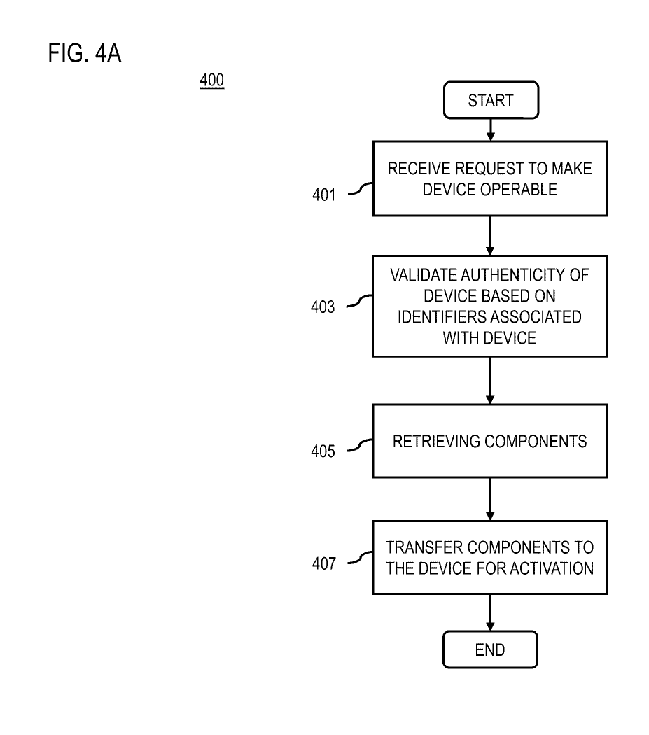

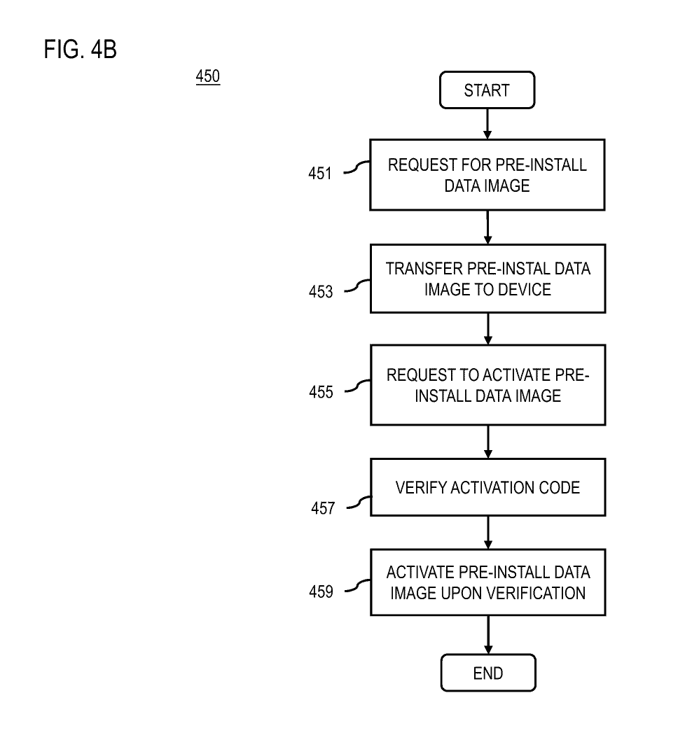

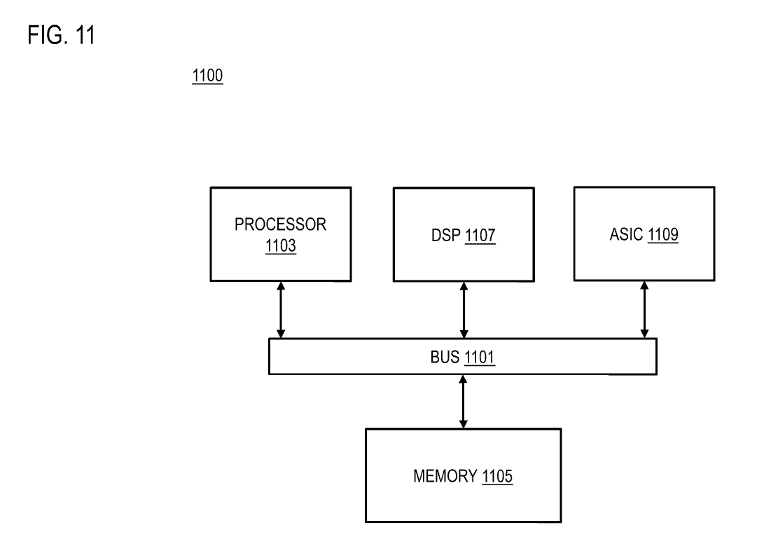

FIGS. 4A and 4B are flowcharts of a process for activating a device, according to various embodiments. FIG. 4A is a flowchart of a process for activating a device that is inoperable, according to one embodiment. In one embodiment, the activation platform 109 performs the process 400 and is implemented in, for instance, a chip set including a processor and a memory as shown in FIG. 11. In step 401, the activation platform 117 receives a request to make the UE 101 operable. In one embodiment, the components necessary for operating the UE 101 are initially absent in the UE 101, and the UE 101 needs to request to receive these components to activate the UE 101. The components may be software components, or hardware components, or a combination thereof. If the components hardware components, they may be chips or cards that may be inserted to the UE 101 to activate the UE 101. If the components are software components, for example, when the UE 101 is first manufactured, these software components may be left out of the UE 101 to make the UE 101 inoperable, thereby deterring thefts. A pre-existing portion of the software (the software without the necessary software components) may be flashed only to an one time programming (OTP) part of the memory for the UE 101 at a manufacturing facility of the UE 101, and the other portions of the memory may be flashed with the software components as well as other information such as content, credentials and language as well as any other local variants needed or selected at retail. In another example, the UE 101 may be flashed completely at the manufacturing facility of the UE 101 with a complete software application to activate the UE 101 for testing purposes, and at least some portions (e.g. the software components) of the software application may be erased before leaving the manufacturing facility to make the UE 101 inactive. In this case, the information about the testing may remain at the UE 101 to guarantee quality and validity of testing.

In step 403, in response to the request, the activation platform 109 validates an authenticity of the UE 101 based on identifiers associated with the UE 101. In order to prevent thefts, the pre-existing portion of the software application as well as the software components may be encrypted. Thus, the authenticity of the UE 101 may need to be validated in order for the UE 101 to receive the encrypted software component. The authenticity of the UE 101 may depend on the identifiers associated with the UE 101 such as a product code (e.g. hardware information about the UE 101), software code (e.g. information about the pre-existing software in the UE 101 that needs the software components), regional information, validity period and etc. This may also prevent using counterfeit devices from obtaining the software components to activate the counterfeit devices. Further, these identifiers used for checking the authenticity of the UE may also be a time-dependent code that is triggered at a set time (e.g. random time, periodically, etc). Thus, if the time-dependent code is used, the authenticity may be checked periodically even after the purchase of the UE 101. In step 405, the components are retrieved. If the components are software components, the activation platform 109 may retrieve the software components. The software components corresponding to the UE 101 may be retrieved from the service provider 119, so that the software components may be transferred to the UE 101.

In step 407, the components are transferred to the UE 101 for activation of the UE 101. If the components are hardware components, then the hardware components may be installed at the UE 101 to activate the UE 101, for example. If the components are software components, then the software components may be transferred to the UE 101 via any available communication means. The software to be transferred to the UE 101 to make the UE 101 operable may include a firmware to boot the UE 101. The firmware may be flashed to the OTP memory in the UE 101. Further, the software components may be the software components without any limitations such as limitations on the features of the software or a time-limitation (e.g. trial period), thus making the UE 101 operable indefinitely without any limits. On the other hand, if the request to activate the UE 101 in step 401 is to request to preview, then the software components transmitted to the UE 101 may be components with limitations, such as time limitation (e.g. operable for a ten-hour trial period) or limitations in software features (e.g. demo software) or limitations in hardware features (e.g. limited features of some hardware portions, disabled hardware portions, switching off some hardware portions or making some hardware portions inoperable). In one example, the UE 101 may also be a demo device with demo software flashed to the UE 101, such that the UE 101 needs to be sent back to the manufacturer before making it fully operable. Further, in some embodiments, the transmission of the software components may first be authenticated first before the transmission is performed. For example, the transmission may not be authenticated until after a transaction of payment is made. The activation platform 109 may also specify content, configurations and credentials for the software, before authenticating the transfer, such that the transfer may be performed based on the content, the configurations and the credentials.

In one embodiment, the retail device 111 may include a heartbeat detector (not shown), to detect a heartbeat signal associated with a UE 101. Thus, if the heartbeat signal of the UE 101 is absent, then this may show that the UE 101 has been removed from the designated location without proper permission. Thus, the heartbeat detection may prevent or deter theft of the UE 101. The heartbeat detection may also communicate with the retailer or even with the manufacturer to block operation or activation of the UE 101 that has been removed from the designated location without permission. However, the heartbeat signal can be detected again if the UE 101 is returned to the designated location. If the heartbeat signal of the UE 101 is absent for a period of time without receiving any signal indicating that the UE 101 is removed with permission, then an alert may be generated to show a sign of a missing UE 101. The signal indicating that the UE 101 is permissibly removed from the designated location may be the request to make the device operable.

In one embodiment, the transmission of the software components may be performed by active tags or passive tags. The activation platform 109 may communicate with the data transfer manager 103 of the UE 101 such that the tag server 317 and a tag hardware (not shown) can be used to receive the software components. The tag hardware can be any short range radio or wireless transfer protocol such as Ultra High Frequency/Near Field Communication (UHF/NFC) and/or Impulse based Ultra Wideband (I-UWB). In this case, if a single memory tag does not have sufficient memory capacity to store the entire software components for activating the UE 101, then multiple memory tags may be associated together to store the software components.

The service provider 119 may include any type of source that can provide information such as software components. Thus, the service provider 119 may include a server of a service provider available on the Internet. The service provider 119 may also include a storage device or a computer at a retail store. The storage device or the computer at the retail store may also be connected to the server of the service provider to exchange information. Further, the service provider 119 may include another UE 101. Then, one UE may work like a service provider 119 to another UE. The service provider 119 may also be a sales box of a memory device that includes content such as software components and is capable of transmitting information about the content of the software components. The memory device in the sales box may include a memory tag, a tag server and tag hardware capable of the short range radio or wireless transfer protocol. Then, if the user brings the UE 101 closer to the sales box including the memory device, the content in the memory device may be transmitted to the UE 101 such that the user may view the content in the memory device. However, the content in the memory device may not be transmitted to the UE 101 to be stored or installed in the UE 101 until the UE 101 passes a certain authentication process (e.g. a sign of transaction of payment). Alternatively or additionally, the content list or part of the content list may be transmitted to the UE 101 to enable the user to view it.

In another embodiment, if the UE 101 starts experiencing faulty behaviors due to the software application within the UE 101, then the activation platform 109 may deactivate the UE 101. Then, the activation platform 109 may diagnose the faulty problems, locate necessary software components to repair the faulty problems, and transmit the software components to the UE 101. Upon receipt of the updated software components, the diagnosed faulty problems may be repaired and the UE 101 may be activated to work properly.

In one embodiment, there may be at least three statuses for the UE 101, a dead device, a raw device and an update device. The dead device has no operating system, no CMT (chip multi-threading) images and no Applications, and thus does not run because of lack of software or firmware that can operate the device. The raw device has an operating system or CMT images, but has no applications for the device. The update mobile device has the operating system, CMT image and applications, but the software applications in the mobile device may be outdated. These statuses may be recorded in the memory tag in the UE 101 such that the necessary software components may be easily identified by reading the memory tag in the UE 101. The types of the software components that can be transmitted to the UE 101 may include at least three classes of image including an OS image, a driver image, and an application image, corresponding to the dead device, the raw device and the update device, respectively. The source (e.g. the retailer device 111) that provides these images may also have memory tags storing a corresponding one of these classes of images. For example, there may be an OS image tag, a driver image tag, and an application image tag, which are sources for the OS image, the driver image, and the application image, respectively. If the OS image is transmitted to the UE 101 which is considered the dead device, then the OS image will complete the operating system in the UE 101 and enable the UE 101 to boot up using the operating system. This OS image may be an firmware image that makes the UE 101 operable using the firmware. If the driver image is transmitted to the UE 101 considered the raw device, then the application corresponding to the driver image in the UE 101 will be activated. Further, the application image is transmitted to the UE 101 considered the update device, then the updates provided by the application image are applied in the software applications in the UE 101.

If there are multiple sources (i.e. memory tags) representing the service provider 119, the user may wave around or sweep the UE 101 along the multiple sources. The information from the memory tags may be communicated to the UE 101 using the short range radio or wireless transfer protocol discussed above. In one embodiment, the order by which different classes of tags corresponding to classes of images are selected is determined, and the memory tags are accessed according to this order. In one example, the order may be determined such that the OS tag is selected first, and the driver tag is selected second, the application tag is selected third, and any other tags are selected last. Then, as the user waves or sweeps the UE 101 along multiple tags, the tags are accessed in this order. In another embodiment,

In this example, before transmitting the driver image to the UE 101, the OS image may need to be transmitted to the UE 101 first to activate the dead device, and make it available to run other software applications. Further, transmission of the driver image to the UE 101 may be necessary to activate the corresponding software application, before transmitting the application image to the UE 101 to provide updates to the software applications. The user may also choose not to follow this order (e.g. turn off the option of following the order) and receive the classes of images in a pseudo-random fashion.

In another embodiment, there may be a target or a preferred class of tag for the UE 101 to seek based on the status of the UE 101. Thus, if there are multiple sources and one of the source has a tag corresponding to the status, then an alert may be made in the UE 101 to notify that the source for the preferred tag has been located. The alert may be in a form of sound, visual or tactile (i.e. vibrate). The strength of the alert may increase or fade, as the UE 101 becomes closer to or further away from the tag of a preferred class, respectively.

In one example, transferring of the software components including tags of different classes may be performed in a way that the software components are flashed at the OTP portion of the memory or stored at the memory in the UE 101. In another example, transferring of the software components may not involve any flashing or storing of the software components at the UE 101. Rather, the software components may be provided to the UE 101 as long as the UE 101 is connected to the source of the software components, in a real-time fashion, and may no longer be provided to the UE 101 if the source is disconnected. For example, the OS image may be provided to the UE 101 via a data connection such as a short range wireless connection via a tag hardware connected to the OS image tag, and as the OS image is transmitted to the UE 101, the OS image may activate the UE 101 or wirelessly boot up the UE 101. This feature is advantageous in that it enables the user to try different software components without flashing or storing the software components at the UE 101, and then select a software component to be flashed or stored. The UE 101 may be wirelessly boot up via the retailer device 111, but may also be wirelessly boot up via another device such as another UE 101. This may be implemented to provide the user an option to try out the UE 101, such that the user can try using the UE 101 that is activated by the software components provided via the data connection without storing the software components in the UE 101. If the user decides to purchase the UE 101, then the software components will be transferred and stored at the UE 101 indefinitely only after the user purchases the UE 101.

Further, additional aid in preventing or deterring theft may be implemented using the EPC (electronic product code) ID assigned to each sales box of software. In one embodiment, the sales box may include an EPC Antenna as a printed circuitry for the EPC ID. The EPC ID may be used to keep track of sales. Upon sale of the sales box of the software, the EPC ID may be disabled for further reading, as a sign of sale. The EPC ID may be disabled physically by physically destroying or damaging the EPC ID circuitry. The EPC ID may also be disabled by powering the EPC Tag and sending a modulated bit via the power to disable EPC ID for further reading. This may be performed via UHF or NFC. Further, if the sales box of the software is returned to the retailer after the purchase, then the disabled EPC ID may be enabled by powering the disabled EPC Tag and sending modulated bits (e.g. access code) to enable the EPC ID. If the record on the EPC IDs indicates that a sales box is missing and there is no record of purchase (i.e. record of disabling the EPC tag), then an alarm may be executed to alert the retailer that the sales box might be stolen.

FIG. 4B is a flowchart of a process for storing a pre-install data image in a device and then activating the data image later, according to one embodiment. In step 451, the activation platform receives a request for a pre-install data image. In step 453, the pre-install data image may be transferred to the UE 101 from the retailer device 111, wherein the pre-install data image may be activated later upon verification of the activation code. When the pre-install data image is transferred from the retailer device 111, the pre-install data image may be a test image of a content selected by the user at the retail. As discussed previously, the transfer of the pre-install data image to the UE 101 from the retailer device 111 may be performed via the short range connectivity, using a writer device in the retailer device 111 to write the pre-install data image to the memory tag 117 of the UE 101, as a binary image, for example. In step 455, the UE 101 sends a request to activate the pre-install data image. Then, in step 457, the activation code for the pre-install data image is verified in order to determine whether to activate the pre-install data image. For example, for verification of the activation code, the activation code in the memory tag 117 of the UE 101 for the pre-install data image may be compared with the code present in the retailer device 111 or the service provider 119, to verify the activation code. This may be performed as a metadata query. Upon verification, before activating the pre-install data image, the UE 101 may check the retailer device 111 or the service provider 119 for any update or fixes, and may further synchronize the pre-install data image with the data in the retailer device 111 or service provider 119. If the activation code is verified, then the pre-install image corresponding to the activation code is activated, as shown in step 459. During the activation, if the UE 101 is in a passive mode, the pre-install data image may be installed and activated from its etag in the memory tag 117, where the binary image is copied. On the contrary, if the mobile device is in a active mode, the pre-install data image may be installed and activated from the main storage memory in the memory 107. After activation, the storage space reserved in the etag is released, and the activated image and/or data is forwarded to the UE 101's main memory for execution. In this embodiment, transfer of the pre-install data image to the UE 101 may be performed using a high bitrate transfer, whereas the transfer of the code related to the activation code may be performed using a lower bitrate transfer. For example, the transfer of the pre-install data image to the UE 101 may be performed via a high bitrate connection without a firewall, whereas the transfer of the code related to the activation code may be transferred via a firewall-enabled connection, which may be a lower bitrate transfer due to the firewall. The code related to the activation may need to be securely transferred, and thus use of the firewall may be beneficial. Although the firewall may cause a lower bitrate transfer, the code related to the activation generally is small, and thus the low bitrate transfer may not cause inconvenience.

In one example of this embodiment, there may be three types of pre-install data image, unlocked image, locked image and masked image. The unlocked image is the image that needs an activation code verification to unlock. The locked image is an image that is linked with a user defined classification, and thus activation of the pre-install data image is performed by unlocking of the image based on the classification in addition to the activation code verification. For example, one image's classification may include features and settings for business, whereas another image may include features and settings for home. The image may change depending on whether the user is at work or at home. Then, the UE 101 may be linked with a global positioning system to automatically determine whether the UE 101 is at work or at home, and unlock the pre-install data image accordingly. The locked image may also be locked for particular device, location or a retailer, such that the image will not be locked unless these conditions regarding these factors are satisfied. The masked images are a set of masked images that can be activated by a same activation code. If there are three different sets of masked images, then three activation codes may be needed to activate all three sets of the masked images. Masking may depend on the type of the UE 101, a retailer location and etc.

In another example of this embodiment, the pre-install data image may be streamed upon activation. Especially for a media file that is the pre-install data image and is streamable, upon verification of the activation code, blocks of data from the media file may be streamed. The streamable content may fit into the memory tag 117 completely or partially. The UE 101 in this example acts as a storage for media. Then, the UE 101 may be connected to a media play device such as a television monitor, such that the UE 101 may stream the media on the television monitor by transmitting blocks of the media. This transmission may be performed via the short range wireless connectivity discussed above. The streamable blocks may be transferred from other NVM storage to the memory tag 118, and the memory tag 118 may be used for buffering for the streaming of the media.

This process shown in FIGS. 4A and 4B is advantageous in that it provides an approach to deter theft of the mobile device. In particular, a non-working device that may be activated after necessary software components (generally upon purchase) provides no or little incentives to steal the non-working device. Further, because software is involved in making the device active, there is no or little cost involved in implementing this approach, as opposed to a physical anti-theft device. In addition, only necessary components may be transmitted to the mobile device, instead of transmitting an entire software application for booting up the mobile device, and thus this process takes a short period of time. Thus, this process reduces the possibility of theft of the mobile device, and thus reduces the cost incurred in preventing the theft while avoiding inconvenience to the customers. The activation platform 109 is a means for achieving these advantages.

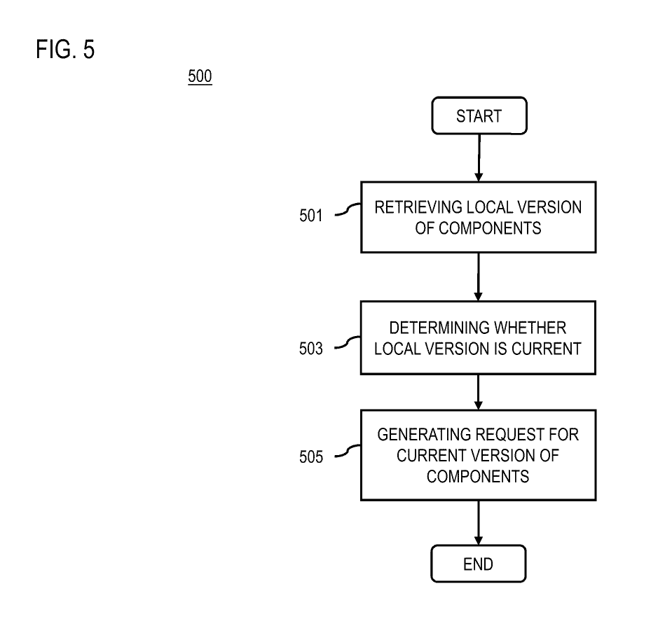

FIG. 5 is a flowchart of a process for providing the most current software components to the UE 101, according to one embodiment. In one embodiment, the activation platform 109 performs the process 500 and is implemented in, for instance, a chip set including a processor and a memory as shown FIG. 11. In step 501, the activation platform 109 retrieves a local copy of the software components that are resident in the local source of the information/data. If the local copy is current (i.e. up-to-date), then the local copy of the software is used for transmission. If the local copy is not current, then the activation platform 109 generates a request for the current copy of the software components. For example, the request for the current copy of the software components may be retrieved from the server of the service provider 119 or the manufacturer of the UE 101. The service provider 119 may authenticate the request by validating information about the requesting device (e.g. the retailer device 111). If the requesting device does not have permission to access the service provider 119 (e.g. counterfeiting device), then the request to obtain the current copy is denied. If the authentication is validated, then the current copy may be transferred to the requesting device such that the requesting device can provide the current copy to the UE 101.

This process is advantageous in that it provides a way to transmit up-to-date software components to the mobile device for the optimal user experience. The activation platform 109 is a means for achieving this advantage.

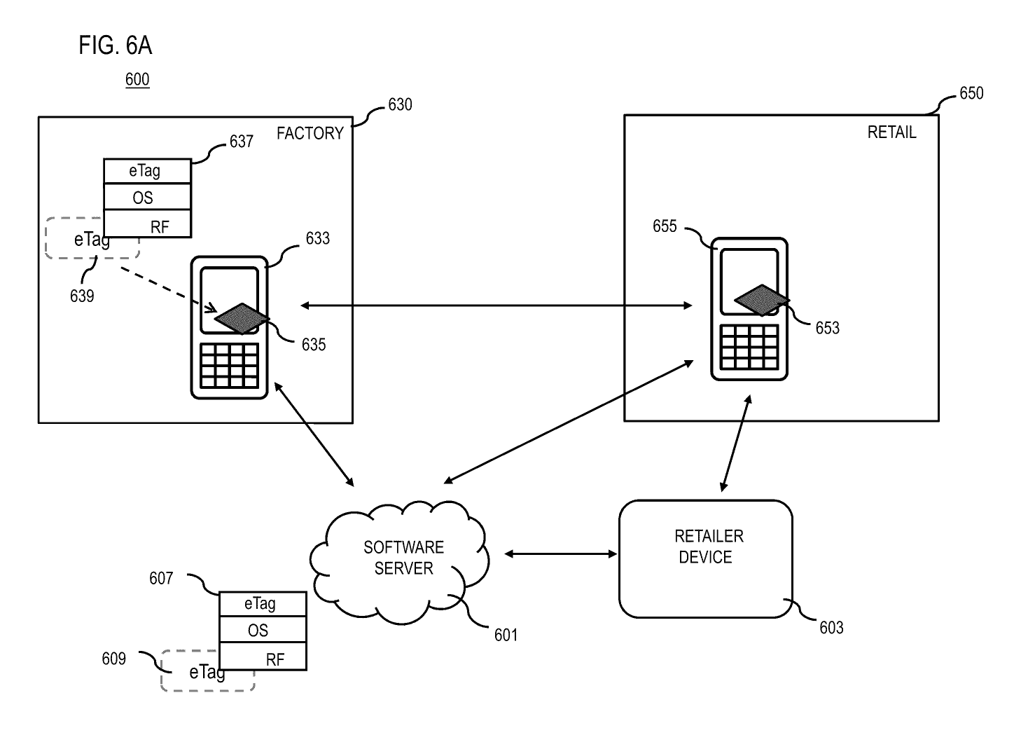

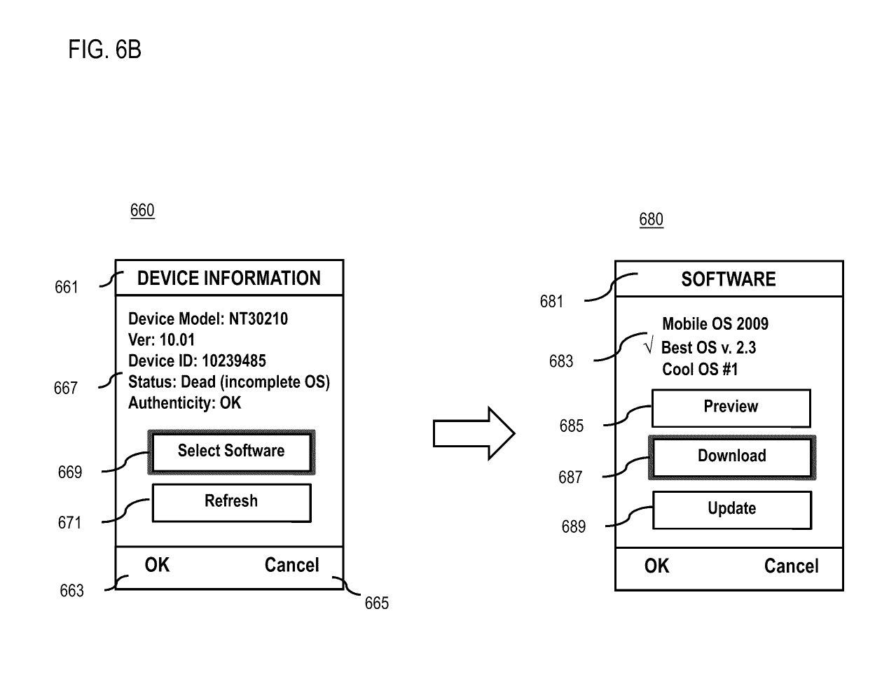

FIGS. 6A-6B are diagrams of the processes for activating a device and user interfaces utilized in the retailer device during the processes of FIGS. 4A and 4B, according to various embodiments. FIG. 6A shows a diagram related to the processes of FIG. 4 to activate an inoperable device upon purchase of the device. As shown in FIG. 6A, the mobile device 633 (i.e. the UE 101) is first manufactured at a factory 630, the mobile device 633 may have a memory tag 635 including software and hardware information about the UE 101, and do not have software components necessary for activating the mobile device 633. The mobile device 633 in the factory 630 may go through diagnostic tests virtually based on the software and hardware information, and virtually provided software components. If the diagnostic tests are performed with satisfying results (i.e. no or little fault diagnostics), then the software and hardware information related to the diagnostic test may be stored in the memory tag 635, along with an OK sign indicating that the diagnostic tests have been performed successfully. The memory tag 635 may include an eTag 639 having set memory allocations 637. This information may also be stored at a software server 601 so that this information may be accessed in other locations. This information may be stored in a form of virtual eTag 609 with virtual eTag memory allocations 607. The virtual eTag 609 refers to the eTag 639 of the device 633 or a tag memory allocation 637. Thus, the virtual eTag 609 with the virtual eTag memory allocation 607 refer to the location of the OS in the memory tag 635 where the OS is stored/executed/run, and also refer to the location of the RF memory tag. The memory tag 635 may be a RF memory tag or there may be a separate RF memory tag residing in the device 633. Then, the same memory allocations 607 may be used when providing software components to the mobile device 655 at a retail store 650. At the retail store 650, if a customer wants to purchase and use the mobile device 655, then the customer needs to acquire software components necessary to activate the mobile device 655. The customer may bring the unpurchased inactive mobile device 655 to the retailer device 603 that is local at the retail store 650. Upon a transaction of the payment for the mobile device 655, the retailer device 603 transmits the software components to the mobile device 655 to activate the mobile device 655. The software components to be transmitted may depend on the information in the virtual eTag 609, which is equivalent to the information in eTag639, as well as the information in the physical eTag 653. The software components may also be transmitted from the software server 601 to the mobile device 655, upon the transaction of the payment. Also, the retailer device 603 may connect to the software server 601 to retrieve software components, and constantly update them, and then provide the retrieved software components to the mobile device 655. In this example, both the software server 601 and the retailer device 603 are considered service provider 119. Further, the mobile device 655 may communicate with the retailer device using a short range radio or wireless transfer protocol. This may be implemented at the memory tag 653 with a tag server and a tag hardware such as such as Ultra High Frequency/Near Field Communication (UHF/NFC) and/or Impulse based Ultra Wideband (I-UWB), as discussed previously.

In another embodiment, the memory tag 653 may receive a pre-install data image from the retailer device 603, and the pre-install data image may be later activated by an activation code. For example, when a user chooses a pre-install data image from the retailer device, wherein the pre-install data image may be available locally at the retailer device 603 or remotely at the software server 601, the pre-install data image may be transferred to the mobile device 653. Then, the pre-install data image may be activated by verifying the activation code. The activation code may be present within the UE 101 as a part of the memory tag 653, and this activation code may be compared with the code present in the retailer device 603 or the software server 601, for verification of the activation code. When the activation code is verified, the pre-install data image is activated. If the pre-install data image is initially stored at the memory tag 653, then upon activation, the pre-install data image may be moved to a main storage medium (not shown).

FIG. 6B shows examples of user interfaces implemented in the retailer device 603, according to one embodiment. After a payment is received for the mobile device 655, a request is made to the retailer device 603 to make the mobile device 655 operable. The mobile device 655 may be connected to the retailer device 603 to receive software components for activating the mobile device 655. When the mobile device 653 is connected to the retailer device 603, the retailer device 603 retrieves information about the mobile device 653. The user interface 660 show device information, as shown in the title 661, and the information about the mobile device 653 is shown on the main screen 667. The main screen 667 shows the device model, the version, the device ID, the status and the authenticity of the device. If there is something wrong with the authenticity of the mobile device 653, the retailer device 603 may show an alert and prevent from proceeding to transfer software. Because the authenticity is OK in this example, the options of “Select Software” 669 and “Refresh” 671 are displayed. The Select Software option enables the customer to select from a list of software components. The Refresh option 663 enables the customer to update any information about the mobile device 653 connected to the retailer device 603. The options can be selected using the OK button 663, and any operation may be canceled by the Cancel option 665. When the Select Software option is selected, the user interface shows software, as shown in the title 681. The main screen 683 displays three different operating system options as software components. In this example, Best OS v. 2.3 is selected, as indicated by the check mark. After the software is selected, three options are displayed. The Preview option 685 enables the customer to access preview of the selected software. The preview of the software may allow the customer to use the software and/or the mobile device 653 with limited features or with a time limit. The Download option 687 enables the customer to download the software components to the mobile device 653 so that the non-working mobile device 653 can be activated. The Update option 689 may be selected to check if there is any update available for the listed software, in order to provide the current version of the software.

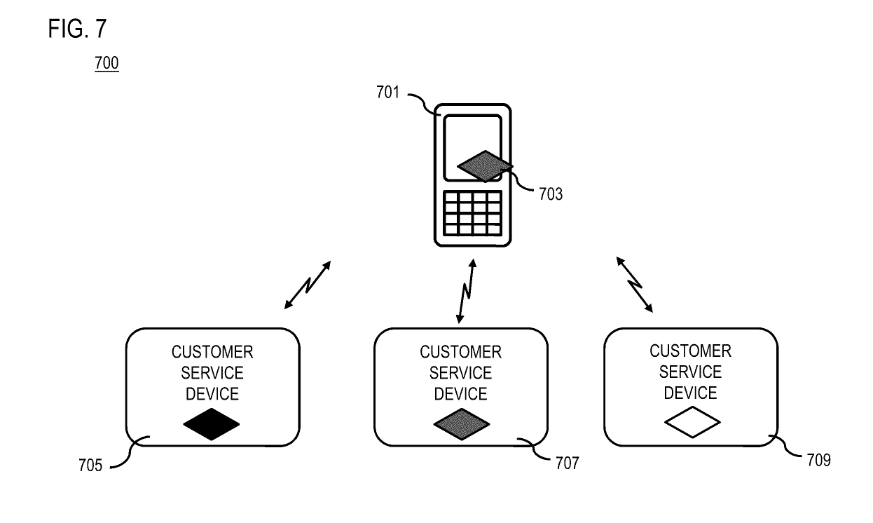

FIG. 7 is a diagram of selectively receiving a data image source by waving and sweeping the user equipment near the data image source, according to one embodiment. The mobile device 701 with a memory tag 703 having a tag server and a tag hardware for a short range radio or wireless transfer protocol may be waved or swept around various retailer devices 705, 707 and 709, until a desired retailer device with a matching tag is found. In this example, the retailer devices 705, 707 and 709 may include three different tags for an OS image (black), a driver image (gray) and an application image (white). In one embodiment, if the memory tag 703 has a tag for the driver image (gray), and is brought near the retailer device with the corresponding tag 707, then the mobile device 701 will execute an alert. The alert may be in a form of sound, visual, or tactile (e.g. vibration). This helps the user to find out which retailer device has software components that the mobile device 701 needs. In another embodiment, there may be an order in which the images are accessed. For example, the order may be set such that the OS image is to be accessed first, and the driver image is to be accessed second and the application image is accessed third. Then, the image is transferred in this order, as the mobile device 701 is swept across these retailer devices 705, 707 and 709. The transfer of these images to the mobile device 703 in this order may also be performed in a stacked-based memory allocation manner, such that if the OS image is transferred first, and the driver image is transferred second, and the application image is transferred third, then if the images are to be erased or taken out, the image that was transferred to the mobile device lastly will be taken out first. In this example, if the images are to be taken out, the application image is taken out first, and then the driver image is taken out, and then the OS image is taken out lastly.

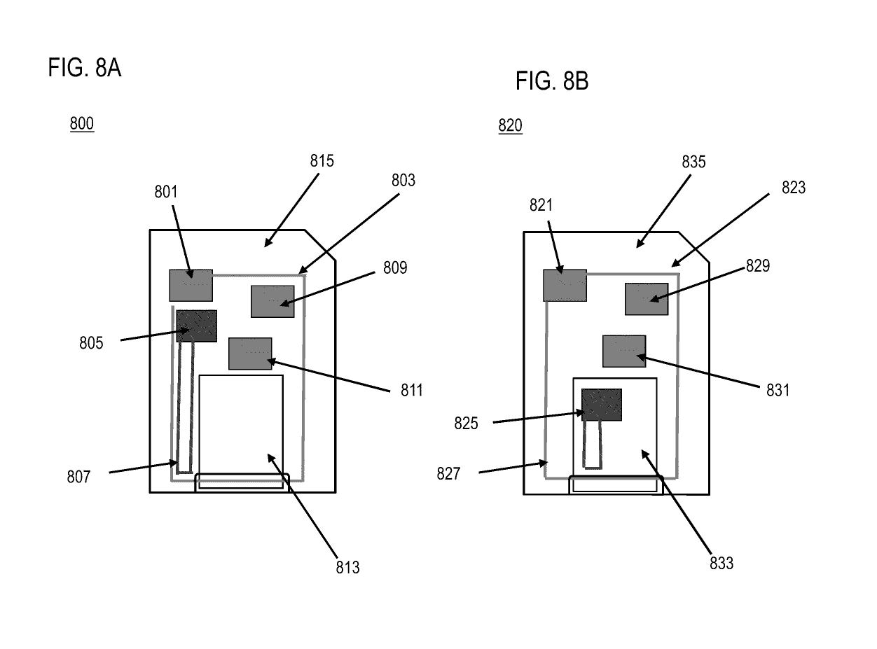

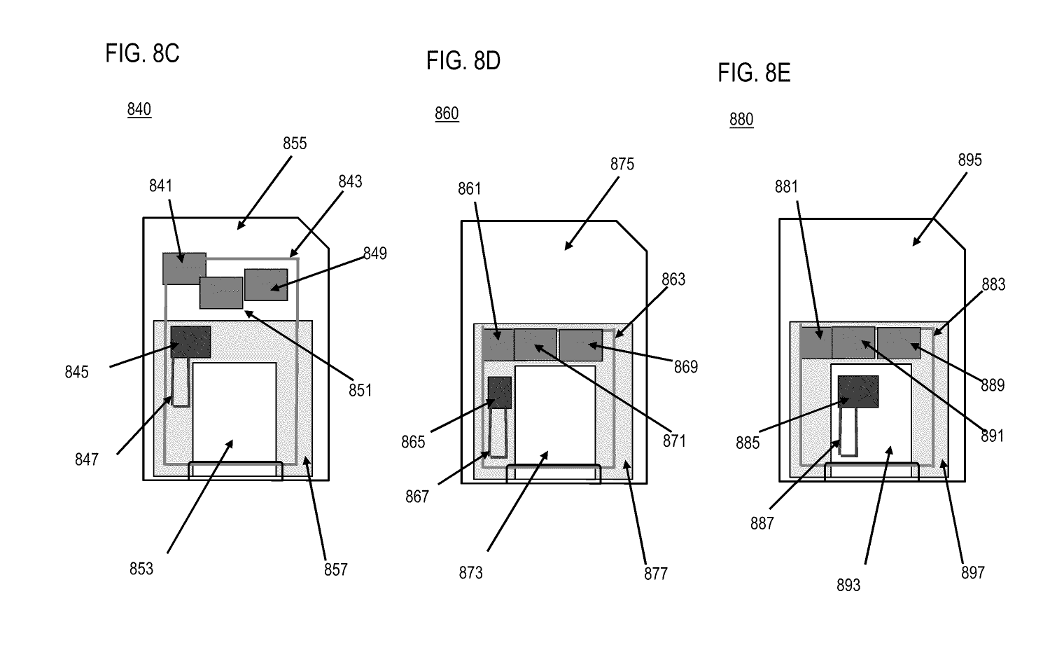

FIGS. 8A-8E are example diagrams of a memory tag with a tag hardware for short range wireless communication, according to various embodiments, when using a memory card and a memory card adaptor. For example, the memory card may include universal file storage (UFS) such as a microSD card and the memory card adaptor may be an adaptor that can accommodate the memory card and fit into a secure digital card (SD card) slot. The microSD card may fit into a sub-adaptor such as a miniSD adaptor such that a mobile device with a miniSD slot can read the microSD card via the miniSD adaptor, and the miniSD adaptor may fit into an SD adaptor. Thus, the memory tag shown in the examples of FIGS. 8A-8E may be connected to a device including the UE 101 and the retailer device 111, as an add-on peripheral, to provide the memory tag function for the device. In FIGS. 8A˜8E, if the mobile device can take the memory card adaptor, then the UHF RF can be used for a lower bitrate transfer and the UWB can be used for a higher bitrate transfer. FIG. 8A shows a memory card adaptor 815 with a memory card 813 that can be inserted into the adaptor 815. FIG. 8A also shows that a UHF RF 801, a UHF antenna 803, UWB RF 805, UWB antenna 807, a clock synthesis 809 and a supply voltage 811 are located in the memory card adaptor 815. UWB has a higher bitrate than the UHF. FIG. 8B shows a memory card adaptor 835 with a memory card 833 that can be inserted into the adaptor 835. FIG. 8B also shows that a UHF RF 821, a UHF antenna 823, a clock synthesis 829 and a supply voltage 831 are located in the memory card adaptor 835, whereas UWB RF 825 and UWB antenna 827 are located in the memory card 833. Thus, if only a slot for the memory card is available in the mobile device, UWB RF can be used for high bitrate data transfer. Although the memory card may not have any clock synthesis or supply voltage, when the memory card is inserted in to the mobile device, the mobile device may provide the clock and the power.

FIG. 8C shows that a memory card 853 can be inserted into the sub-adaptor 857, which can be inserted into the adaptor 855. FIG. 8C also shows that a UHF RF 841, a UHF antenna 843, a clock synthesis 849 and a supply voltage 851 are located in the memory card adaptor 855, whereas UWB RF 845 and UWB antenna 847 are located in the sub-adaptor 857. Therefore, if only a slot for the sub-adaptor is available in the mobile device, UWB RF can be used for high bitrate data transfer. Although the sub-adaptor 857 may not have any clock synthesis or supply voltage, when the sub-adaptor 857 is inserted in to the mobile device, the mobile device may provide the clock and the power. Further, FIG. 8D also shows that a memory card 853 can be inserted into the sub-adaptor 857, which can be inserted into the adaptor 855. In FIG. 8D, a UHF RF 841, a UHF antenna 843, UWB RF 845, UWB antenna 847, a clock synthesis 849 and a supply voltage 851 are located in the sub-adaptor 877. Therefore, if only a slot for the sub-adaptor or the adaptor is available in the mobile device, then the UHF RF can be used for a lower bitrate transfer and the UWB RF can be used for a higher bitrate transfer. In FIG. 8D, the memory card 873 does not have any means for RF communication. FIG. 8E also shows that a memory card 853 can be inserted into the sub-adaptor 857, which can be inserted into the adaptor 855. FIG. 8E also shows that a UHF RF 881, a UHF antenna 883, a clock synthesis 889 and a supply voltage 891 are located in the sub-adaptor 897, whereas UWB RF 885 and UWB antenna 887 are located in the memory card 893. Therefore, if only a slot for the sub-adaptor or the adaptor is available in the mobile device, then the UHF RF can be used for a lower bitrate transfer and the UWB RF can be used for a higher bitrate transfer. But, if only a slot for the memory card is available in the mobile device, only UWB RF can be used for high bitrate data transfer. Although the memory card 893 may not have any clock synthesis or supply voltage, when the memory card 893 is inserted in to the mobile device, the mobile device may provide the clock and the power.

The card adaptor shown in FIGS. 8A-8E may be connected to a PC via a USB connection. Then, the UFS card and the card adaptor(s) with the short range wireless communication capability are connected to the PC. This connectivity may provide the PC with a short range wireless communication capability. This may also provide a wireless UFS-XIP (execute in place) implementation for the PC.

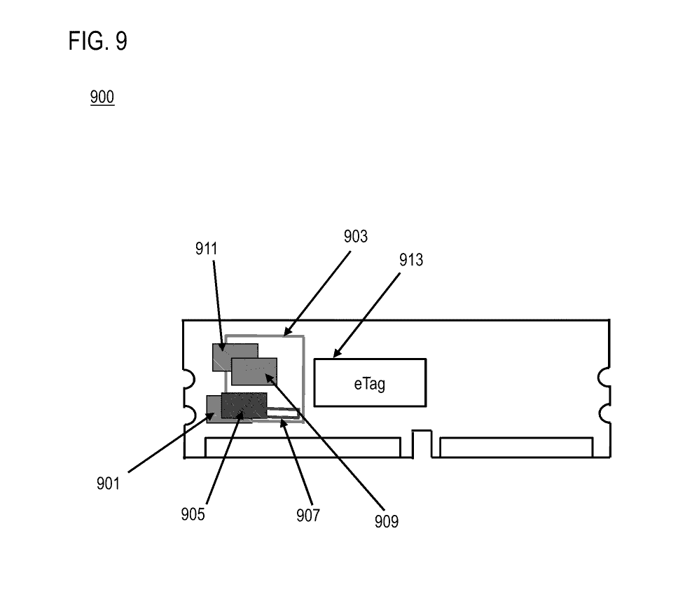

FIG. 9 shows an example of a volatile memory that may be used for an eTag, for environments where DIMM/SIMM type memories are applied, such as personal computers, notebooks, and other consumer electronic devices, according to one embodiment. The DIMM/SIMM volatile memory may used to form a passive RF memory tag using an eTag and a tag hardware such as Ultra High Frequency/Near Field Communication (UHF/NFC) and/or Impulse based Ultra Wideband (I-UWB). This DIMM/SIMM volatile memory with a passive RF memory tag may be placed in a sales box at retail, and may be flashed via the passive RF communication. Thus, the DIMM/SIMM volatile memory in this example may include similar features for the tag hardward as the examples shown in FIG. 8. The DIMM/SIMM volatile memory includes a UHF RF 901, a UHF antenna 903, UWB RF 905, UWB antenna 907, a clock synthesis 909 and a supply voltage 911. The DIMM/SIMM volatile memory may also include an eTag 913 as a non-volatile memory, thereby forming an UFS-XIP memory for a PC environment.

The processes described herein for activating a device may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

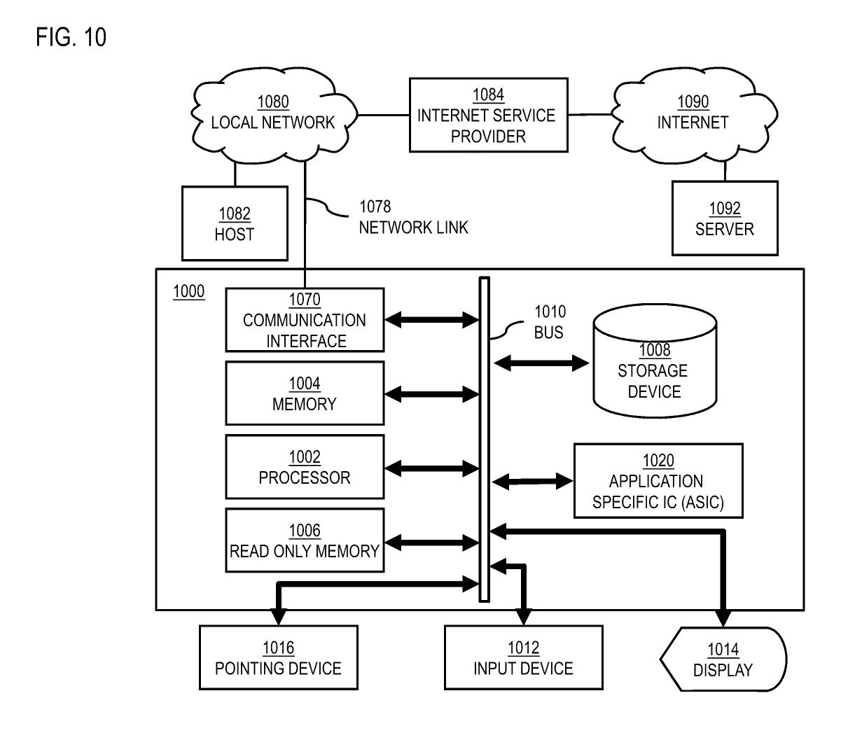

FIG. 10 illustrates a computer system 1000 upon which an embodiment of the invention may be implemented. Although computer system 1000 is depicted with respect to a particular device or equipment, it is contemplated that other devices or equipment (e.g., network elements, servers, etc.) within FIG. 10 can deploy the illustrated hardware and components of system 1000. Computer system 1000 is programmed (e.g., via computer program code or instructions) to activate a device as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps of activating a device.

A bus 1010 includes one or more parallel conductors of information so that information is transferred quickly among devices coupled to the bus 1010. One or more processors 1002 for processing information are coupled with the bus 1010.

A processor (or multiple processors) 1002 performs a set of operations on information as specified by computer program code related to activating a device. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1000 also includes a memory 1004 coupled to bus 1010. The memory 1004, such as a random access memory (RAM) or other dynamic storage device, stores information including processor instructions for activating a device. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for activating a device, is provided to the bus 1010 for use by the processor from an external input device 1012, such as a keyboard containing alphanumeric keys operated by a human user, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT) or a liquid crystal display (LCD), or plasma screen or printer for presenting text or images, and a pointing device 1016, such as a mouse or a trackball or cursor direction keys, or motion sensor, for controlling a position of a small cursor image presented on the display 1014 and issuing commands associated with graphical elements presented on the display 1014. In some embodiments, for example, in embodiments in which the computer system 1000 performs all functions automatically without human input, one or more of external input device 1012, display device 1014 and pointing device 1016 is omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of application specific ICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1170 coupled to bus 1010. Communication interface 1170 provides a one-way or two-way communication coupling to a variety of external devices that operate with their own processors, such as printers, scanners and external disks. In general the coupling is with a network link 1178 that is connected to a local network 1080 to which a variety of external devices with their own processors are connected. For example, communication interface 1170 may be a parallel port or a serial port or a universal serial bus (USB) port on a personal computer. In some embodiments, communications interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1010 into signals for a communication connection over a coaxial cable or into optical signals for a communication connection over a fiber optic cable. As another example, communications interface 1170 may be a local area network (LAN) card to provide a data communication connection to a compatible LAN, such as Ethernet. Wireless links may also be implemented. For wireless links, the communications interface 1170 sends or receives or both sends and receives electrical, acoustic or electromagnetic signals, including infrared and optical signals, that carry information streams, such as digital data. For example, in wireless handheld devices, such as mobile telephones like cell phones, the communications interface 1170 includes a radio band electromagnetic transmitter and receiver called a radio transceiver. In certain embodiments, the communications interface 1170 enables connection to the communication network 105 for activating a device.

The term “computer-readable medium” as used herein refers to any medium that participates in providing information to processor 1002, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1008. Volatile media include, for example, dynamic memory 1004. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1020.

Network link 1178 typically provides information communication using transmission media through one or more networks to other devices that use or process the information. For example, network link 1178 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system 1000 can be deployed in various configurations within other computer systems, e.g., host 1082 and server 1092.

At least some embodiments of the invention are related to the use of computer system 1000 for implementing some or all of the techniques described herein. According to one embodiment of the invention, those techniques are performed by computer system 1000 in response to processor 1002 executing one or more sequences of one or more processor instructions contained in memory 1004. Such instructions, also called computer instructions, software and program code, may be read into memory 1004 from another computer-readable medium such as storage device 1008 or network link 1178. Execution of the sequences of instructions contained in memory 1004 causes processor 1002 to perform one or more of the method steps described herein. In alternative embodiments, hardware, such as ASIC 1020, may be used in place of or in combination with software to implement the invention. Thus, embodiments of the invention are not limited to any specific combination of hardware and software, unless otherwise explicitly stated herein.

The signals transmitted over network link 1178 and other networks through communications interface 1170, carry information to and from computer system 1000.

Computer system 1000 can send and receive information, including program code, through the networks 1080, 1090 among others, through network link 1178 and communications interface 1170. In an example using the Internet 1090, a server host 1092 transmits program code for a particular application, requested by a message sent from computer 1000, through Internet 1090, ISP equipment 1084, local network 1080 and communications interface 1170. The received code may be executed by processor 1002 as it is received, or may be stored in memory 1004 or in storage device 1008 or other non-volatile storage for later execution, or both. In this manner, computer system 1000 may obtain application program code in the form of signals on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1178. An infrared detector serving as communications interface 1170 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

FIG. 11 illustrates a chip set or chip 1100 upon which an embodiment of the invention may be implemented. Chip set 1100 is programmed to activate a device as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of providing user interface navigation information associated with the availability of services. Chip set or chip 1100, or a portion thereof, constitutes a means for performing one or more steps of activating a device.

In one embodiment, the chip set or chip 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1117, or one or more application-specific integrated circuits (ASIC) 1109. A DSP 1117 typically is configured to process real-world signals (e.g., sound) in real time independently of the processor 1103. Similarly, an ASIC 1109 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1100 includes merely one or more processors and some software and/or firmware supporting and/or relating to and/or for the one or more processors.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to activate a device. The memory 1105 also stores the data associated with or generated by the execution of the inventive steps.

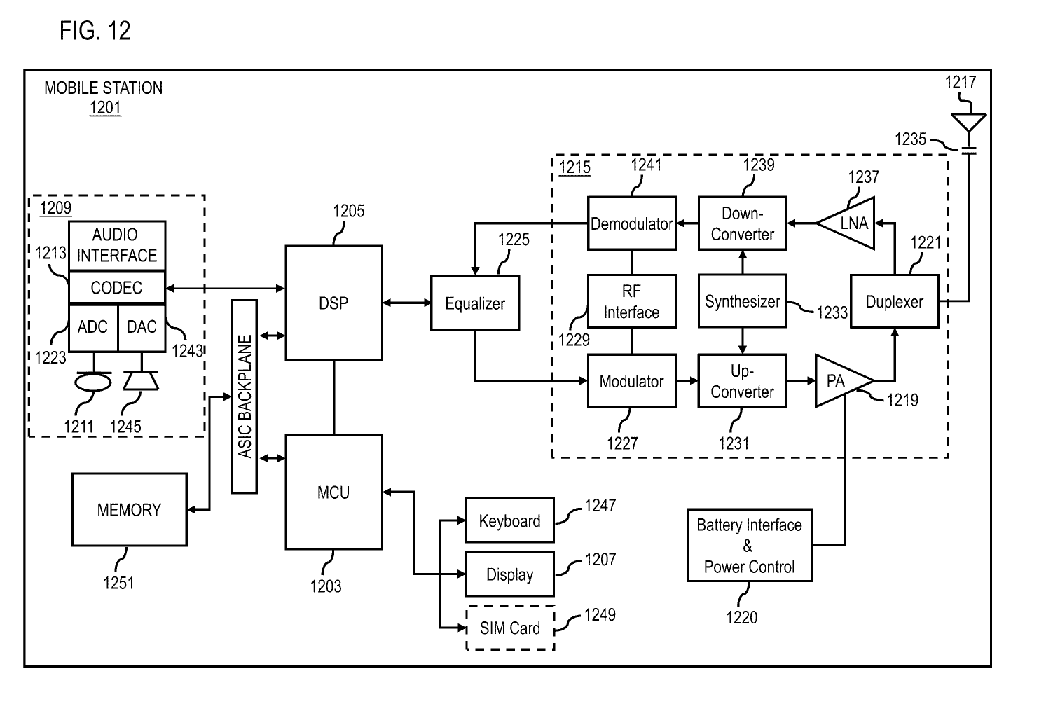

FIG. 12 is a diagram of exemplary components of a mobile terminal (e.g., handset) for communications, which is capable of operating in the system of FIG. 1, according to one embodiment. In some embodiments, mobile terminal 1200, or a portion thereof, constitutes a means for performing one or more steps of activating a device. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps of activating a device. The display 12 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203—which can be implemented as a Central Processing Unit (CPU) (not shown).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile terminal 1201 to activate a device. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
receiving a request to make a device operable, wherein the device is in an inoperable state because one or more components for operating the device are absent from the device;
in response to the request, validating an authenticity of the device based, at least in part, on one or more identifiers associated with the device;
retrieving the components; and
causing, at least in part, transfer of the components to the device to make the device operable.

2. A method of claim 1, further comprising:
causing, at least in part, authentication of the transfer of the components,
wherein the transfer of the components is based, at least in part, on the authentication.

3. A method of claim 1, further comprising:
retrieving a local version of one or more of the components;
determining whether the local version is current; and
generating a request for a current version of the one or more components based, at least in part, on the determination.

4. A method of claim 1, further comprising:
detecting one or more tags associated with the device or another device; and
identifying the components based, at least in part, on the one or more tags or a combination of the one or more tags.

5. A method of claim 1, further comprising:
detecting a heartbeat signal associated with the device;
determining an absence of the heartbeat signal for a period of time without receiving the request; and
generating an alert based, at least in part, on the determination.

6. A method of claim 1, further comprising:
receiving a request to preview one or more of the components; and
causing, at least in part, presentation of the components or respective limited use versions of the components on the device, another device, or a combination thereof.

7. A method of claim 1, wherein the device includes one or more base components in a one time programming memory of the device, and the base components are combined with the transferred components to make the device operable.

8. A method of claim 1, wherein the request is initiated by a transaction at a retailer of the device, and wherein the device is delivered to the retailer in the inoperable state.

9. A method of claim 1, wherein the transfer is via a communication system built into the device, provided to the device in a peripheral, or a combination thereof.

10. A method of claim 1, wherein the software components relate to operating system components, driver components, applications, or a combination thereof.

11. An apparatus comprising:
at least one processor; and
at least one memory including computer program code for one or more computer programs,
the at least one memory and the computer program code configured to, with the at least one processor, cause the apparatus to perform at least the following,
receive a request to make a device operable, wherein the device is in an inoperable state because one or more components for operating the device are absent from the device;
in response to the request, validate an authenticity of the device based, at least in part, on one or more identifiers associated with the device;
retrieve the software components; and
cause, at least in part, transfer of the software components to the device to make the device operable activation.

12. An apparatus of claim 11, wherein the apparatus is further caused, at least in part, to: cause, at least in part, authentication of the transfer of the components,
wherein the transfer of the components is based, at least in part, on the authentication.

13. An apparatus of claim 11, wherein the apparatus is further caused, at least in part, to:
retrieve a local version of one or more of the components;
determine whether the local version is current; and
generate a request for a current version of the one or more components based, at least in part, on the determination.

14. An apparatus of claim 11, wherein the apparatus is further caused, at least in part, to:
detect one or more tags associated with the device or another device; and
identify the components based, at least in part, on the one or more tags or a combination of the one or more tags.

15. An apparatus of claim 11, wherein the apparatus is further caused, at least in part, to:
detect a heartbeat signal associated with the device;
determine an absence of the heartbeat signal for a period of time without receiving the request; and
generate an alert based, at least in part, on the determination.

16. An apparatus of claim 11, wherein the apparatus is further caused, at least in part, to:
receive a request to preview one or more of the software components; and
cause, at least in part, presentation of the software components or respective limited use versions of the software components on the device, another device, or a combination thereof.

17. An apparatus of claim 11, wherein the device includes one or more base software components in a one time programming memory of the device, and the base software components are combined with the software components to activate the device.

18. An apparatus of claim 11, wherein the transmission of the software components is to a one time programming memory of the device.

19. An apparatus of claim 11, wherein the transmission is via a communication system built into the device, provided to the device in a peripheral, or a combination thereof.

20. An apparatus of claim 11, wherein the software components relate to operating system components, driver components, applications, or a combination thereof.
